(19) United States
(12) Patent Application Publication
(10) Pub. No.: US 2006/0072909 A1
(43) Pub. Date: Apr. 6, 2006

(54) Optical storage controller with a serial ATA interface

(75) Inventors: Cheng-Jung Wang, Taipei (TW); Hsueh-Wei Huang, Taipei (TW); Chih-Wen Liu, Taipei (TW)

Correspondence Address: BIRCH STEWART KOLASCH & BIRCH, PO BOX 747, FALLS CHURCH, VA, 22040-0747, US

(73) Assignee: Ali Corporation

(21) Appl. No.: 11/019,355

(22) Filed: Dec. 23, 2004

(30) Foreign Application Priority Data
Oct. 5, 2004 (TW) 93130133

(51) Int. Cl. H04N 5/85

(52) U.S. Cl. 386/126

(57) ABSTRACT

The present invention describes an optical storage controller with serial transmission. The controller is used as the signal transmission between an optical disk controller and a MPEG decoder to enhance the transmission rate. Therein a sharing memory is adopted to save memory usage. The optical storage controller couples with the MPEG decoder using a serial ATA interface, and they share the same sharing memory.

### BACKGROUND OF THE INVENTION

1. Field of the Invention

This invention relates to an optical storage control with a serial ATA transmitting interface, and more particularly to a signal transmission between an optical disk controller and a MPEG decoder.

2. Description of Related Art

Optical disk devices, such as DVDs and CDs, often employ a playback system to reproduce video/audio data from a DVD or a CD. An optical storage controller transmits video/audio data from the media to a MPEG decoder via a specific transmission interface. The optical storage controller then decodes and playbacks the data.

The above-mentioned method for reading video/audio optical disks of the prior art is achieved through the optical disk drive and the playback system. Through the relationship between the computer and the optical disk drive, the video/audio signal is retrieved from the optical disk drive, and transmitted-to the computer. Next, the CPU of the computer decodes the signal using a MPEG technique, and reproduces the video/audio content.

Reference is made to FIG. 1 showing a servo driver 101 that is employed to control a motor 102 and an optical pickup unit (OPU) 104, upon which a laser head is mounted. The motor 102 is responsible for driving the optical disk 103. The optical pickup unit 104 reads the signal sent from the optical disk 103. The signal from the optical disk 103 is then amplified by a signal amplifier 105 and transmitted to a digital signal processor (DSP) 107. After that, the digital signal processor 107 takes charge of operating the controlling signal via a micro controller 108, and transmits the signal to a servo controller 117 in order to control the read/write of optical disk 103.

The aforementioned structure uses a first memory 106 as a data buffer to process and transmit the signal. After going through the digital signal processor 107, the signal from the optical disk is transmitted to a decoding unit 110. It is then decoded into a specific code that can be recognized by a host end, such as MPEG I/II. Meanwhile a second memory 109 is acts as another data buffer since the transmission before and after the decoding unit 110 is often unsynchronized.

Furthermore, after a decoding process via a transmitting interface 111, the signal is transmitted to the host end. The transmitting interface 111 can be an advanced technology attachment packet interface (ATAPI), which is a protocol generally used to control storage devices such as hard disk, an optical disk, a tape and so on.

The central processing unit (CPU) 112 of the host receives the video/audio signal (MPEG) via the transmitting interface 111. The MPEG decoder 114 then further decodes the signal into a normal AV signal. A third memory 113 is used as data buffer for the MPEG decoder 114, and is controlled by a micro controller 115. Finally, a play unit 116 plays the video/audio content back.

FIG. 2 shows an integrated optical disk player. A motor 202 of a servo driver 205 is used to drive an optical disk 201, a laser head of an optical pickup unit 203 reads the optical signal reflected from the optical disk 201, and the optical signal is amplified by a signal amplifier 204. The signal is then transmitted to an optical disk controller 206, which, in the meantime, receives a driving signal from the motor 202. The optical disk controller 206 couples with a micro controller 209, which can optimize the AV signal. The AV signal is transmitted to a MPEG decoder 208 via a parallel interface there between. Otherwise, the MPEG decoder 208 with a memory buffer 207 disposed therein, shares the micro controller 209 with the optical disk controller 206. Finally, a play unit 210 plays the content.

Thus, an individual memory is employed in the prior art, and a parallel interface is used to transmit the data. Since the optical disk controller also requires its own memory, the cost of the player is higher.

A parallel ATA is commonly used to enhance the transmission rate up to 100 Mbps. However, this is not easy to achieve. Furthermore, since the parallel ATA is a one-way transmission system, it regularly produces noise. As opposed to the prior art, which employs a parallel interface between the optical disk controller and the MPEG decoder, the present invention employs a serial ATA (SATA) to be the transmitting interface there between. This is because a SATA restrains noise and the transmission rate is much higher than that of a parallel interface. Obviously, the interface is a critical point.

The serial ATA interface has the following advantages:

1. A point-to-point link doesn't need a host-client relationship.

2. A cable using SATA interface can be thinner and longer.

3. The bandwidth of the serial ATA is currently 150 Mbps. 300 Mbps is expected to be reached soon, rising to 600 Mbps or more in the future.

4. The connector of the SATA interface is hot swappable and blind mating.

5. All data and controlled information is processed using cyclic redundancy checks (CRC) on the SATA interface to check the accuracy of data using polynomials. After reading each fixed size or block, a following CRC bit will be checked as receiving data. The accuracy of processed information is thereby improved.

The present invention discloses an optical storage controller employing serial transmission, which can simplify the layout of the circuit board and shrink the size of the chips, thus improving the efficiency of the media player.

### SUMMARY OF THE DISCLOSURE

The present invention discloses an optical storage controller using serial transmission with a higher transmission rate as the interface between an optical disk controller and a MPEG decoder. Moreover, memory usage is reduced since the optical disk controller and MPEG decoder share the same memory. The optical storage controller with serial transmission comprises an optical storage controller including at least a servo controller, an optical disk controller and a MPEG decoding system all connected via a serial ATA interface with the optical storage controller and sharing the same memory.

### BRIEF DESCRIPTION OF DRAWINGS

The present invention will be readily understood by the following detailed description in conjunction with the accompanying drawings, in which:

FIG. 1 is a block diagram of an optical storage controller of the prior art;

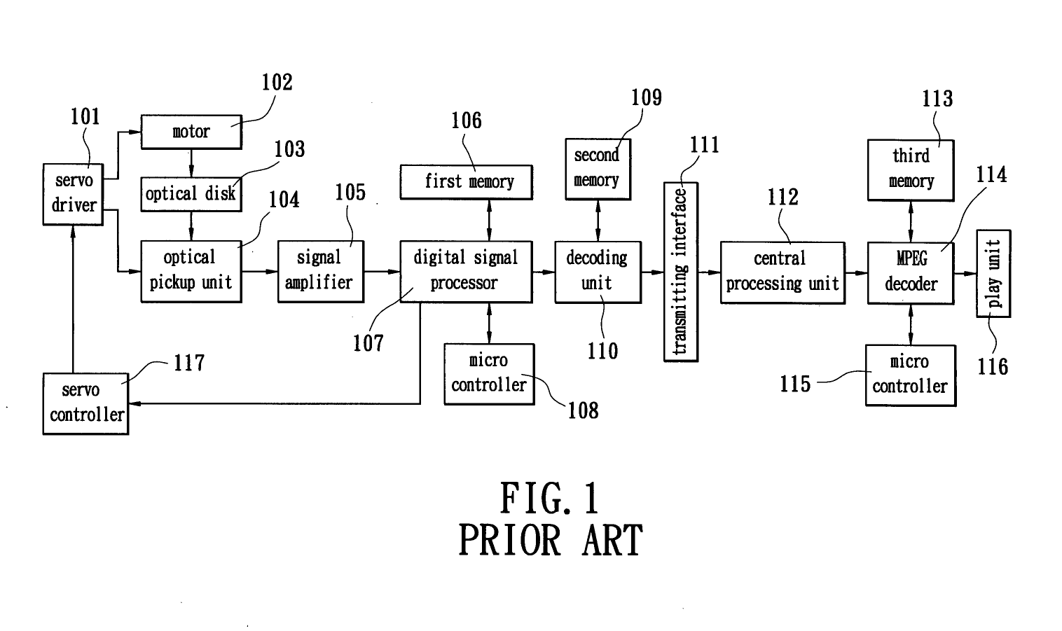

FIG. 2 is a block diagram of an integrated optical disk controller of the prior art; and

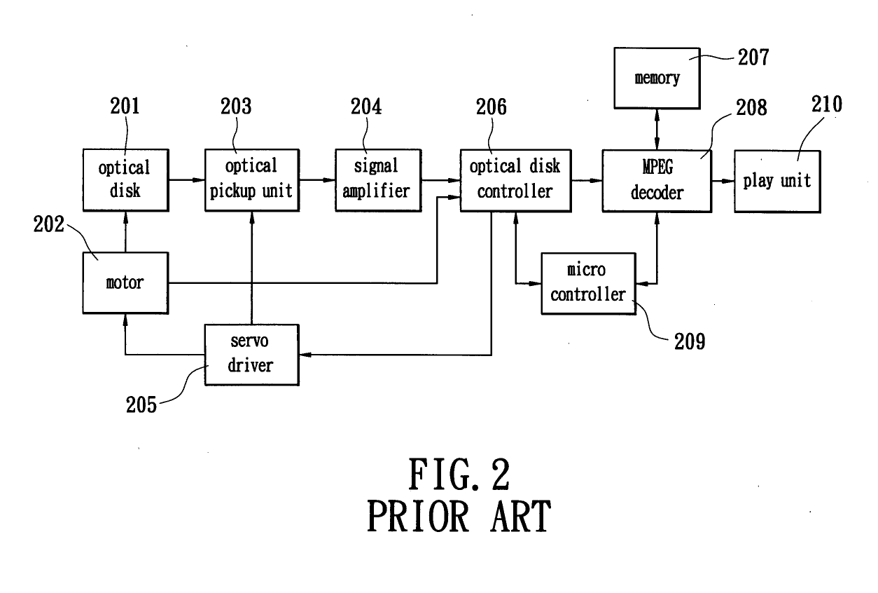

FIG. 3 is a block diagram of a preferred embodiment of the optical storage controller of the present invention.

### DETAILED DESCRIPTION OF THE PREFERRED EMBODIMENTS

The objectives and characteristics of the present invention will now be described with reference to the attached drawings. A serial ATA interface is employed as the transmission interface between an optical storage controller and a MPEG decoder.

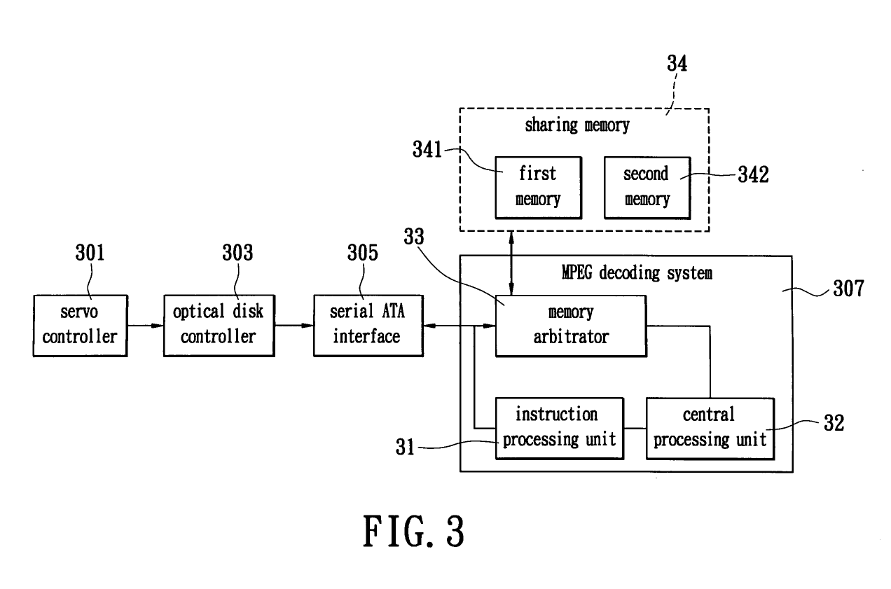

Please refer to the preferred embodiment for the structure of the present invention shown in FIG. 3. A servo controller and a MPEG decoder share the same memory. A memory arbitrator is used for the purpose of memory allotment. Therefore, memory usage is saved. In addition, the serial ATA (SATA) is employed as the transmission interface since SATA enhances the transmission rate of a player.

FIG. 3 shows the schematic connecting diagram between the optical storage controller and the MPEG decoding system. The optical storage controller can be separated into a servo controller 301 and an optical disk controller 303, and further includes at least an optical disk driver, an optical head. Some parts of the optical system structure are not shown in the drawing as they are not relevant to this invention. However, they should be well known to specialists in the field.

The servo controller 301 comprises the driving system of an optical disk, an optical pickup unit and so on. The optical disk controller 303 is the controlling system for processing the signal, from the optical disk, such as signal amplifying, decoding, and analog-to-digital converting.

The optical disk controller 303 encodes the signal retrieved from the optical disk into MPEG code. It then transmits the code to the MPEG decoding system 307 via a serial ATA interface 305. Finally, the code is decoded by the MPEG decoding system 307 and played back by a play unit. The aforementioned MPEG decoding system 307 is used to convert the digital data stored in an optical storage system into video/audio format, which can be played back in a play unit. Additionally, the MPEG decoding system 307 can be used as a decoding chip or as decoding program executed in the computer.

Furthermore, the MPEG decoding system 307 is a video/audio-decoding device coupled with the optical storage controller, and further coupled with a sharing memory 34. The sharing memory 34 is used as a dynamic memory such as a first memory 341, and a read-only memory such as a second memory 342. Accordingly, the first memory 341 of the sharing memory 34 is the buffer memory required by a decoding/encoding process in the optical disk controller 303. The first memory 341 is also the data buffer shared with the MPEG decoding system 307. Therefore, the sharing memory 34 is used to reduce costs.

Furthermore, the second memory 342 can be firmware storage for the optical disk controller 303 and the MPEG decoding system 307 respectively.

The sharing memory 34 coupled with the MPEG decoding system 307 is allotted by a memory arbitrator 33, which couples with both a central processing unit 32 and an instruction processing unit 31. Moreover, the memory arbitrator 33 allots the memory for information processing and procedure controlling for the central processing unit 32. The instruction processing unit 31 is used to manage the requirements of the MPEG decoding system 307 and receive instructions from the central processing unit 32.

The serial ATA interface is employed as the transmission interface between the optical disk controller and the MPEG decoding system and has following advantage:

1. A point-to-point link doesn't need a host-client structure.

2. A cable using SATA interface can be thinner and longer.

3. The bandwidth of the serial ATA is currently 150 Mbps. 300 Mbps is expected to be reached soon, rising to 600 Mbps or more in the future.

4. The connector of the SATA interface is hot swappable and blind mating.

5. All data and controlled information is processed using a cyclic redundancy check (CRC) on the SATA interface, which is used to check the accuracy of the system.

The present invention provides a serial ATA interface employed as the transmission interface between the MPEG decoding system 307 and the optical disk controller 303. Besides the servo controller 301, the optical disk controller 303 and the MPEG decoding system 307 also share the same sharing memory 34 as shown in FIG. 3. The present invention fulfills the goals of enhancing the transmission rate and reducing costs.

The invention may be embodied in other specific forms without departing from the sprit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. An optical storage controller with serial ATA interface, comprising:
an optical storage controller, including at least a servo controller and an optical disk controller, coupled with a MPEG decoding system, which is a video/audio decoding device used in said optical storage controller;
a serial ATA interface, which couples with said optical storage controller and said MPEG decoding system; and
a sharing memory, which couples with a memory arbitrator of said MPEG decoding system, is the memory shared with said optical storage controller and said MPEG decoding system.

2. The optical storage controller recited as claim 1, wherein said sharing memory includes at least a dynamic memory and a read-only memory.

3. The optical storage controller recited as claim 1, wherein said MPEG decoding system includes at least a central processing unit and an instruction-processing unit.

4. The optical storage controller recited as claim 1, wherein said MPEG decoding system can be a decoding chip, or decoding program.

5. The optical storage controller recited as claim 1, wherein a dynamic memory of said sharing memory is a memory buffer required by said optical disk controller for decoding/encoding.

6. The optical storage controller recited as claim 1, wherein a read-only memory of said sharing memory is firmware storage of said optical disk controller and said MPEG decoding system respectively.

7. The optical storage controller recited as claim 1, wherein said memory arbitrator couples with said optical storage controller via said serial ATA interface.

8. An optical storage controller with serial ATA interface, comprising:
an optical storage controller, at least including a servo controller, an optical disk controller, and an optical disk driving system;
a MPEG decoding system, which is a video/audio decoding system, coupling with said optical storage controller;
a serial ATA interface coupling with said optical storage controller and said MPEG decoding system; and
a sharing memory including at least a dynamic memory and a read-only memory shared by said optical storage controller and said MPEG decoding system, and coupling with a memory arbitrator of said MPEG decoding system, said memory arbitrator couples with said optical storage controller via said serial ATA interface.

9. The optical storage controller recited as claim 8, wherein said MPEG decoding system includes at least a central processing unit and an instruction-processing unit.

10. The optical storage controller recited as claim 8, wherein said MPEG decoding system can be a decoding chip or a decoding program.
